(19) United States
(12) Patent Application Publication
(10) Pub. No.: US 2024/0013745 A1
(43) Pub. Date: Jan. 11, 2024

(54) DISPLAY PANEL AND DISPLAY DEVICE

(71) Applicant: TCL China Star Optoelectronics Technology Co., Ltd.`, Shenzhen (CN)

(72) Inventors: Jhenwei HE, Shenzhen (CN); Jinfeng LIU, Shenzhen (CN); Fengcheng XU, Shenzhen (CN)

(73) Assignee: TCL China Star Optoelectronics Technology Co., Ltd., Shenzhen (CN)

(21) Appl. No.: 17/417,434

(22) PCT Filed: May 20, 2021
(86) PCT No.: PCT/CN2021/094771

§ 371 Date: Nov. 17, 2022

(30) Foreign Application Priority Data
May 13, 2021 (CN) 202110521122.5

(51) Int. Cl. G09G 3/36

(52) U.S. Cl. CPC G09G 3/3688; G09G 3/3696; G09G 2330/021; G09G 2320/028; G09G 2320/0673; G09G 2320/0276; G09G 2310/0291; G09G 2310/08

(57) ABSTRACT

A display panel and a display device are provided. The display panel includes a power management module and a voltage conversion module electrically connected between the power management module and a plurality of data lines to convert a plurality of groups of grayscale voltages from a plurality of groups of gamma binding-point voltages generated from the power management module and transmit the grayscale voltages to the plurality of data lines, which allows two adjacent data lines to receive different grayscale voltages, thereby allowing liquid crystal molecules to deflect more in the display panel to remedy a problem of color shift of viewing angles.

### BACKGROUND OF INVENTION

### Field of Invention

The present application relates to the field of display technology and particularly to a display panel and a display device.

### Description of Prior Art

Because optical characteristics of liquid crystals are affected by viewing angles and voltages, when display panels are viewed laterally at a relatively large angle range, color shift problems can occur. In prior art, viewing angles are generally remedied by designing pixel structures in 8-domain forms or through algorithms. However, 8-domain pixel structures can reduce light transmittance rate of the display panels, and overall grayscale brightness curves can be shifted by improvement of algorithm of adjusting pixel voltages, resulting in high electric level information being lost and reducing an overall display grayscales.

### SUMMARY OF INVENTION

Embodiments of the present application provide a display panel and a display device, which can remedy a problem of color shift of display panels.

One embodiment of the present application provides a display panel. The display panel includes a power management module, a driving chip, and a plurality of data lines. The plurality of data lines includes a first data line and a second data line which are adjacent. The power management module is configured to generate a plurality of different groups of gamma binding-point voltages. The plurality of groups of the gamma binding-point voltages include a first-group gamma binding-point voltage and a second-group gamma binding-point voltage. The driving chip includes a voltage conversion module. The voltage conversion module is electrically connected between the power management module, the first data line, and the second data line. The voltage conversion module is configured to convert the first-group gamma binding-point voltage into a first-group grayscale voltage and outputs the first-group grayscale voltage to one of the first data line or the second data line and is configured to convert the second-group gamma binding-point voltage into a second-group grayscale voltage and outputs the second-group grayscale voltage to another one of the first data line or the second data line. Wherein, the first-group gamma binding-point voltage is different from the second-group gamma binding-point voltage, and the first-group grayscale voltage is different from the second-group grayscale voltage.

One embodiment of the present application provides a display device. The display device includes the aforesaid display panel.

Compared to prior art, in the display panel and the display device provided by the embodiments of the present application, the display panel includes the power management module, the driving chip, and the plurality of data lines. The plurality of data lines includes the first data line and the second data line which are adjacent. The power management module is configured to generate the plurality of different groups of gamma binding-point voltages. The plurality of groups of the gamma binding-point voltages include the first-group gamma binding-point voltage and the second-group gamma binding-point voltage. The driving chip includes the voltage conversion module. The voltage conversion module is electrically connected between the power management module, the first data line, and the second data line. The voltage conversion module is configured to convert the first-group gamma binding-point voltage into a first-group grayscale voltage and outputs the first-group grayscale voltage to one of the first data line or the second data line, and is configured to convert the second-group gamma binding-point voltage into a second-group grayscale voltage and outputs the second-group grayscale voltage to another one of the first data line or the second data line. Wherein, the first-group gamma binding-point voltage is different from the second-group gamma binding-point voltage, and the first-group grayscale voltage is different from the second-group grayscale voltage, which allows grayscale voltages received by the first data line and the second data line to be different. Therefore, the liquid crystal molecules in the display panel are allowed to deflect more, and compensation in the corresponding direction can be obtained to remedy the problem of color shift of viewing angles when the display panel is observed at different viewing angles.

### DESCRIPTION OF DRAWINGS

FIG. 1 is a structural schematic diagram of a display panel provided by one embodiment of the present application.

FIG. 2 is a schematic diagram of connection of data lines, a power management module, and a driving chip provided by one embodiment of the present application.

FIG. 3A to FIG. 3H are schematic diagrams of connection structures of the data lines, the power management module, and the driving chip provided by embodiments of the present application.

FIG. 4 is a control sequence diagram of gamma selection signals and polarity selection signals provided by one embodiment of the present application.

FIG. 5A to FIG. 5D are schematic diagrams of results of adopting the control sequence illustrated in FIG. 4 to control the connection structures illustrated in FIG. 3A to FIG. 3H.

### DETAILED DESCRIPTION OF EMBODIMENTS

For making the purposes, technical solutions and effects of the present application be clearer and more definite, the present application will be further described in detail below. It should be understood that the specific embodiments described herein are merely for explaining the present application and are not intended to limit the present application.

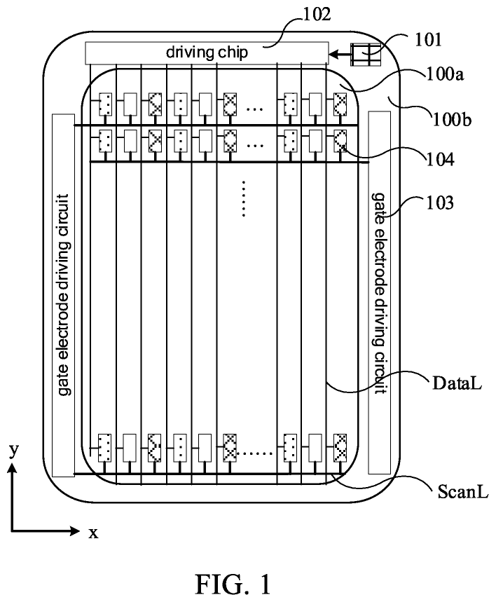

Specifically, please refer to FIG. 1, which is a structural schematic diagram of a display panel provided by one embodiment of the present application. One embodiment of the present application provides a display panel. The display panel includes a display region 100a and a non-display region 100b. Wherein, the non-display region 100b is located at a periphery of the display region 100a. The display region 100a is provided with a display function. The non-display region 100b is not provided with the display function. Optionally, the display panel further includes a sensing region. The display panel includes a sensor corresponding to the sensing region. The display region 100a is located at a periphery of the sensing region. The sensing region can be provided with the display function or is not provided with the display function. The sensor includes a camera, a fingerprint sensor, a distance sensor, etc.

Furthermore, the display panel includes a power management module 101, a driving chip 102, a plurality of stages of gate electrode driving circuits 103, a plurality of pixel driving circuits, and a plurality of sub-pixels 104.

The power management module 101 is located in the non-display region 100b. The power management module 101 is configured to generate a plurality of different groups of gamma binding-point voltages. Wherein, each group of the gamma binding-point voltages can include a plurality of binding-point voltages, for example, a total of 14 binding-point voltages from gamma1 to gamma14 can be included.

The driving chip 102 is located in the non-display region 100b. The driving chip 102 is electrically connected to the power management module 101 to convert the plurality of groups of the gamma binding-point voltage into a plurality of groups of grayscale voltages and to transmit the grayscale voltages to the plurality of data lines DataL. Furthermore, the two adjacent data lines DataL receive different groups of the grayscale voltages. Wherein, the plurality of groups of the grayscale voltages obtained according to the plurality of groups of the gamma binding-point voltages are different, i.e., when same grayscales are displayed, corresponding grayscale voltage values in the plurality of groups of the grayscale voltages are different, and/or polarities of the corresponding grayscale voltage values in the plurality of groups of the grayscale voltages are different.

The plurality of stages of the gate electrode driving circuits 103 are located in the non-display region 100b. The plurality of stages of the gate electrode driving circuits 103 are electrically connected to the plurality of pixel driving circuits through the plurality of scanning lines ScanL. The plurality of scanning lines ScanL extend into the display region 100a from the non-display region 100b along a first direction x.

The plurality of the pixel driving circuits are electrically connected to the driving chip 102 through the plurality of the data lines DataL. The plurality of data lines DataL extend into the display region 100a from the non-display region 100b along a second direction y intersecting with the first direction x.

The plurality of sub-pixels 104 are located in the display region 100a. The plurality of pixel driving circuits are electrically connected to the plurality of sub-pixels 104, so that the plurality of sub-pixels 104 can realize a display function according to the grayscale voltages received by the corresponding pixel driving circuits. Wherein, an arrangement form of the plurality of sub-pixels 104 is not limited to a standard RGB arrangement illustrated in FIG. 1, and a structure of each sub-pixel 104 is not limited to a 4-domain form and an 8-domain form.

Furthermore, the display panel is a passive luminescence display panel. The display panel includes an array substrate, a color filter substrate, a pixel electrode, a common electrode, a sealant, and liquid crystal molecules located between the array substrate and the color filter substrate. Wherein, the array substrate includes the plurality of pixel driving circuits, and each of the sub-pixels includes the pixel electrodes and the liquid crystal molecules. Optionally, the pixel electrodes and the common electrode can both be located on the array substrate; or the pixel electrodes are located on the array substrate, and the common electrode is located on the color filter substrate. It can be understood that the display panel can further include an alignment layer, a polarizer sheet, touch electrodes, etc., which are not shown.

By making any two adjacent data lines DataL receive different groups of the grayscale voltages, electric fields formed between each pixel electrode and the common electrode can be different, thereby allowing the liquid crystal molecules to deflect more. When the display panel is observed at different viewing angles, compensations corresponding to different directions can be obtained, so as to realize the purpose of relieving the color shift of viewing angles.

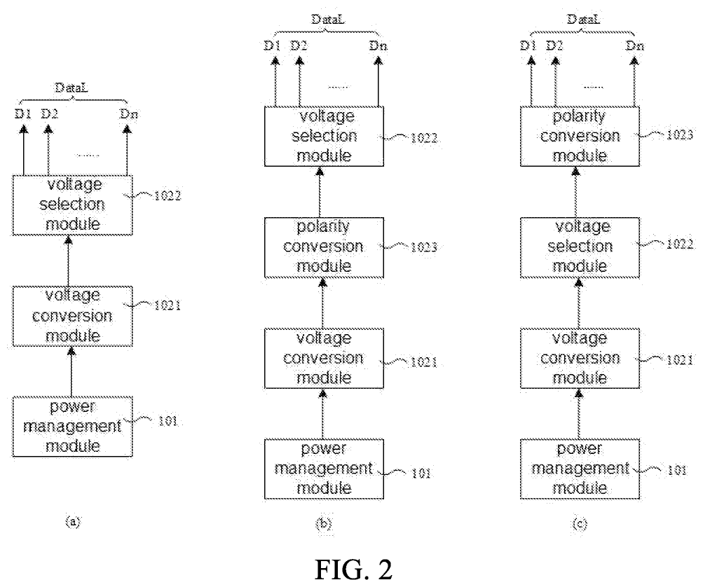

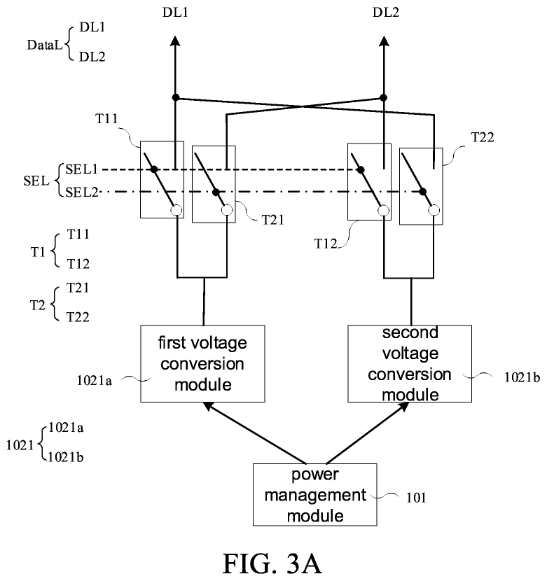

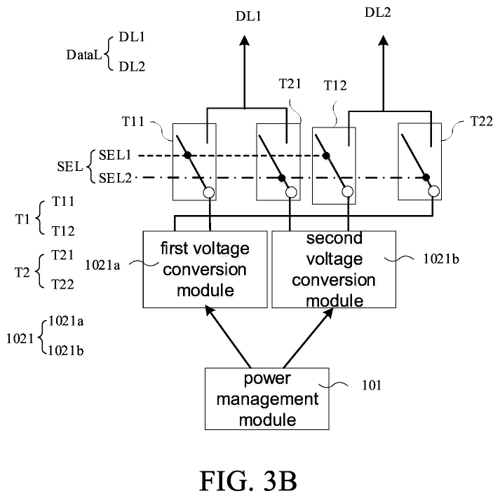

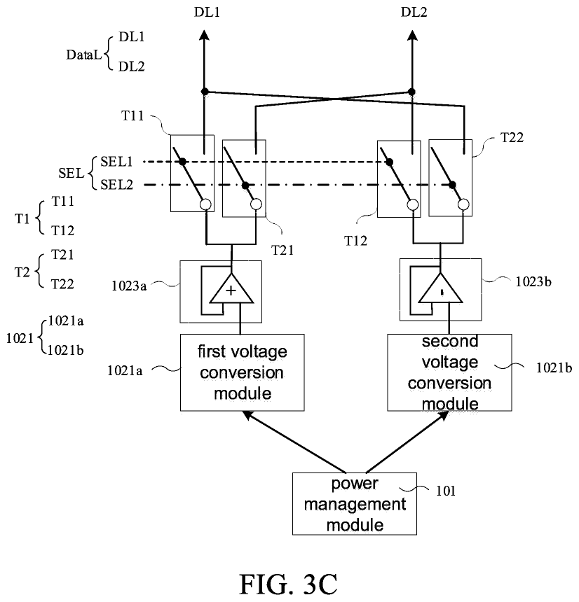

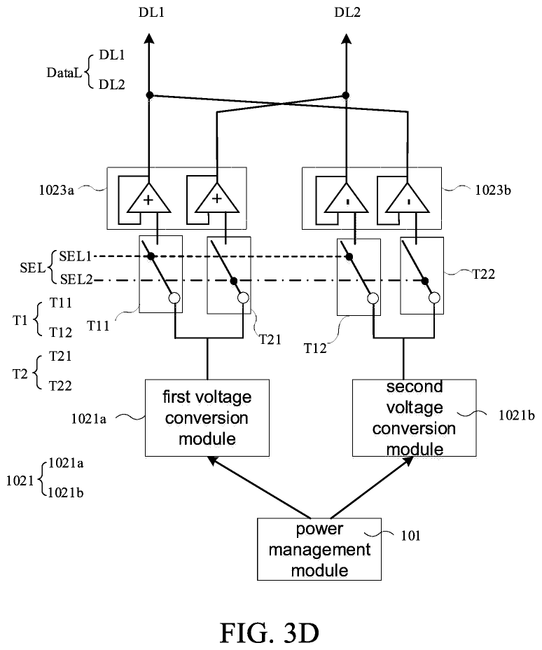

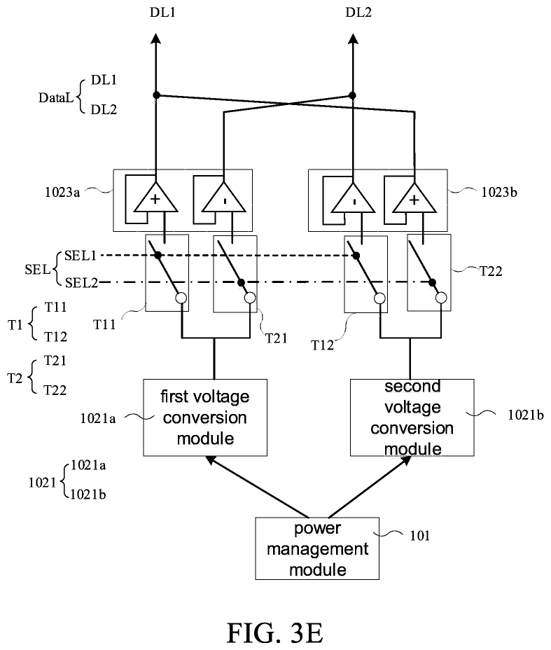

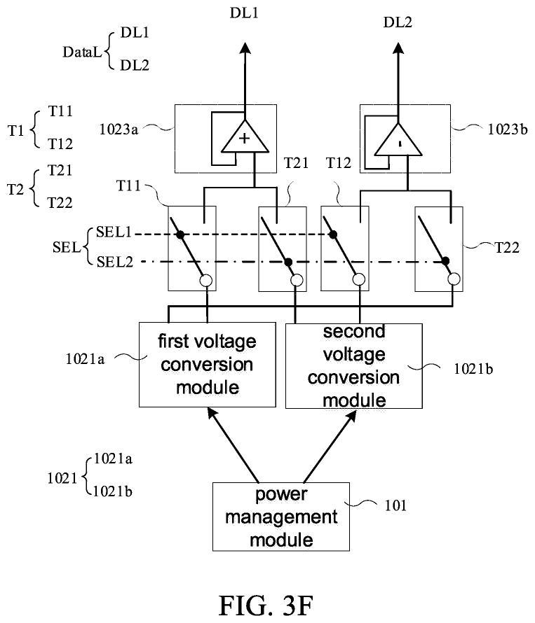

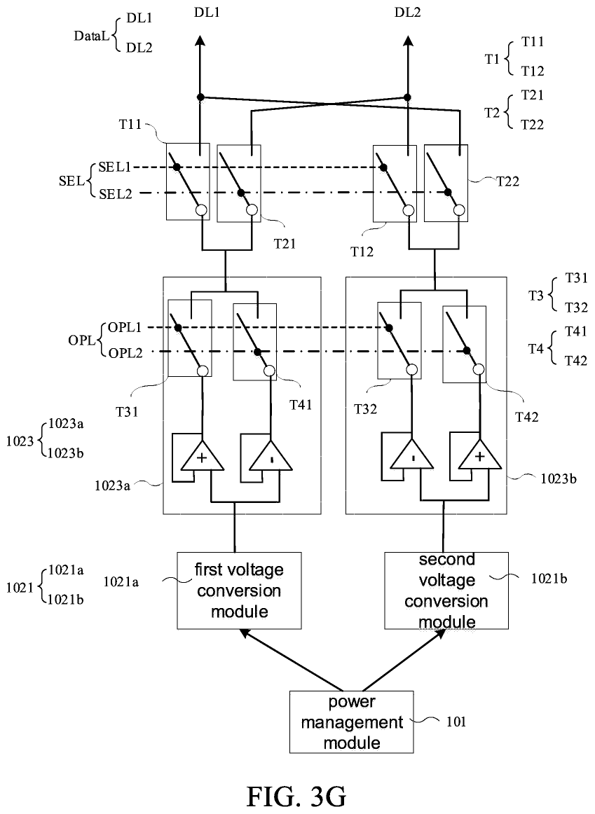

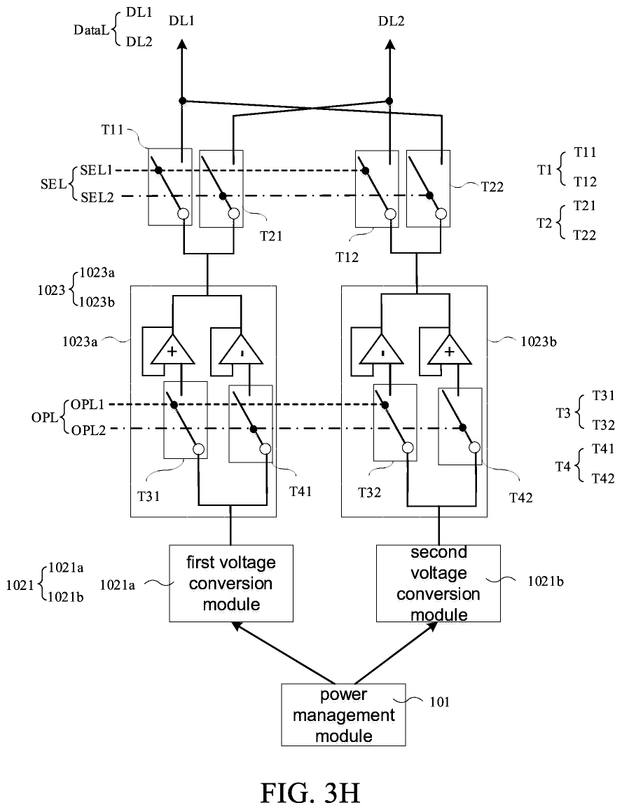

Specifically, please refer to FIG. 2, which is a schematic diagram of connection of data lines, a power management module, and a driving chip provided by one embodiment of the present application, and FIG. 3A to FIG. 3H are schematic diagrams of connection structures of the data lines, the power management module, and the driving chip provided by embodiments of the present application.

The driving chip 102 includes a voltage conversion module 1021. The voltage conversion module 1021 is configured to receive the plurality of groups of the gamma binding-point voltages and to convert the plurality of groups of the gamma binding-point voltages into the plurality of groups of grayscale voltages. Optionally, the driving chip includes a plurality of voltage conversion modules 1021. The plurality of voltage conversion modules 1021 are electrically connected to the power management module 101 and are configured to receive the plurality of groups of the gamma binding-point voltages and to convert the plurality of groups of the gamma binding-point voltages into the plurality of groups of grayscale voltages.

The driving chip further includes a voltage selection module 1022. The voltage selection module 1022 is electrically connected between the voltage conversion module 1021 and the plurality of the data lines DataL, and is configured to allow the two adjacent data lines DataL to receive different groups of grayscale voltages according to gamma selection signals SE.

Furthermore, the voltage selection module 1022 includes a plurality of switch units. Optionally, as illustrated in FIG. 3A, each of the switch units is connected to one of the voltage conversion module 1021 and at least two adjacent data lines DataL, and each of the data lines DataL is connected to two of the switch units; or as illustrated in FIG. 3B, each of the switch units is connected to at least two of the voltage conversion modules 1021 and one of the data lines DataL. Therefore, two adjacent data lines DataL are allowed to be connected to different voltage conversion modules 1021 so as to receive different groups of grayscale voltages.

Furthermore, each of the switch units includes a first switch T1 and a second switch T2 which are interlocked. The first switch T1 in the plurality of switch units is interlocked, and the second switch T2 in the plurality of switch units is interlocked, so that two adjacent data lines DataL are allowed to connect to different voltage conversion modules 1021.

Optionally, the first switch T1 and the second switch T2 can be transistors. Furthermore, a first end of the first switch T1 and a first end of the second switch T2 are both electrically connected to the voltage conversion module 1021; a second end of the first switch T1 and a second end of the second switch T2 are connected to the data lines DataL; a control end of the first switch T1 and a control end of the second switch T2 can be electrically connected to one same gamma selection signal line SEL; and types of the first switch T1 and the second switch T2 are different (for example, the first switch T1 is a P-type transistor, and the second switch T2 is an N-type transistor), so that validly interlocking of the first switch T1 and the second switch T2 is realized. In addition, the control end of the first switch T1 and the control end of the second switch T2 can also be electrically connected to different gamma selection signal lines SEL, and phases of a gamma selection signal loaded in the gamma selection signal line connected to the control end of the first switch T1 and a gamma selection signal loaded in the gamma selection signal line connected to the control end of the second switch T2 are opposite. The control end is a gate electrode. The first end is one of a source electrode or a drain electrode. The second end is another one of the source electrode or the drain electrode.

For ease for understanding, the power management module 101 generating two groups of different gamma binding-point voltages of the first-group gamma binding-point voltage and the second-group gamma binding-point voltage, the driving chip 102 including two groups of voltage conversion modules of a first voltage conversion module 1021a and a second voltage conversion module 1021b, the voltage selection module 1022 including two groups of switch units of the first switch unit and the second switch unit, and the plurality of data lines DataL including two adjacent data lines of a first data line DL1 and a second data line DL2 are taken as an example to describe the present application. Wherein, the first voltage conversion module 1021a is configured to receive the first-group gamma binding-point voltage and to convert the first-group gamma binding-point voltage into a first-group grayscale voltage, and the second voltage conversion module 1021b is configured to receive the second-group gamma binding-point voltage and to convert the second-group gamma binding-point voltage into a second-group grayscale voltage. The first-group gamma binding-point voltage is different from the second-group gamma binding-point voltage, and the first-group grayscale voltage is different from the second-group grayscale voltage.

Specifically, please refer to FIG. 3A to FIG. 3B, which are schematic diagrams corresponding to connection structures of the data lines, the power management module, and the driving chip illustrated in (a) of FIG. 2. Please continue referring to FIG. 3A. The first switch unit is electrically connected between the first voltage conversion module 1021a, the first data line DL1 and the second data line DL2, and the second switch unit is electrically connected between the second voltage conversion module 1021b, the first data line DL1, and the second data line DL2. The first switch unit and the second switch unit are configured to connect one of the first data line DL1 or the second data line DL2 to be electrically connected to one of the first voltage conversion module 1021a or the second voltage conversion module 1021b, so that another one of the first data line DL1 or the second data line DL2 is electrically connected to another one of the first voltage conversion module 1021a or the second voltage conversion module 1021b.

Furthermore, the first end and the second end of the first switch T11 in the first switch unit are electrically connected between the first voltage conversion module 1021a and the first data line DL1. The control end of the first switch T11 is electrically connected to the first gamma selection signal line SEL1. The first end and the second end of the second switch T21 in the first switch unit are electrically connected between the first voltage conversion module 1021a and the second data line DL2. The control end of the second switch T21 is electrically connected to the second gamma selection signal line SEL2. The first end and the second end of the first switch T12 in the second switch unit are electrically connected between the second voltage conversion module 1021b and the second data line DL2. The control end of the first switch T12 is electrically connected to the first gamma selection signal line SEL1. The first end and the second end of the second switch T22 in the second switch unit are electrically connected between the second voltage conversion module 1021b and the first data line DL1. The control end of the second switch T22 is electrically connected to the second gamma selection signal line SEL2.

Please continue referring to FIG. 3B, the first voltage conversion module 1012a is electrically connected between the power management module 101 and the first end of the first switch T11 in the first switch unit and between the power management module 101 and the first end of the second switch T22 in the second switch unit, and the second voltage conversion module 1012b is electrically connected between the power management module 101 and the first end of the second switch T21 in the first switch unit and between the power management module 101 and the first end of the first switch T12 in the second switch unit. The second ends of the first switch T11 and the second switch T21 in the first switch unit are connected to the first data line DL1. The second ends of the first switch T12 and the second switch T22 in the second switch unit are connected to the first data line DL2. The control end of the first switch T11 in the first switch unit and the control end of the first switch T12 in the second switch unit are electrically connected to the first gamma selection signal line SEL1. The control end of the second switch T21 in the first switch unit and the control end of the second switch T22 in the second switch unit are electrically connected to the second gamma selection signal line SEL2.

Please continue referring to FIG. 3A to FIG. 3 B. When the first gamma selection signal SE1 loaded on the first gamma selection signal line SEL1 is valid, the first data line DL1 is connected to the first voltage conversion module 1021a through the first switch T11 in the first switch unit, and the second data line DL2 is connected to the second voltage conversion module 1021b through the first switch T12 in the second switch unit.

Please continue referring to FIG. 3A. When the second gamma selection signal SE2 loaded on the second gamma selection signal line SEL2 is valid, the first data line DL1 is connected to the second voltage conversion module 1021b through the second switch T22 in the second switch unit, and the second data line DL2 is connected to the first voltage conversion module 1021a through the second switch T21 in the first switch unit.

Please continue referring to FIG. 3B. When the second gamma selection signal SE2 loaded on the second gamma selection signal line SEL2 is valid, the first data line DL1 is connected to the second voltage conversion module 1021b through the second switch T21 in the first switch unit, and the second data line DL2 is connected to the first voltage conversion module 1021a through the second switch T22 in the second switch unit.

Optionally, because the display panel includes the plurality of data lines DataL arranged along the first direction x, the first data line DL1 can represent odd-number data lines of an arrangement number in the plurality of data lines DataL, such as a first data line D1, a third data line D3, a fifth data line D5, etc., and the second data line DL2 can represent even-number data lines of an arrangement number in the plurality of data lines DataL, such as a second data line D2, a fourth data line D4, a sixth data line D6, etc.

Optionally, a high electric-level duration of the first gamma selection signal SE1 is equal to a duration of one frame, so that the first data line DL1 is always electrically connected to the first voltage conversion module 1021a in the duration of one frame, or the second data line DL2 is always electrically connected to the first voltage conversion module 1021a in the duration of one frame.

Optionally, a high electric-level duration of the first gamma selection signal SE1 is equal to a charging time of pixels of one row, so that the first data line DL1 is always electrically connected to the first voltage conversion module 1021a in the charging time of the pixels of one row, or the second data line DL2 is always electrically connected to the first voltage conversion module 1021a in the charging time of the pixels of one row.

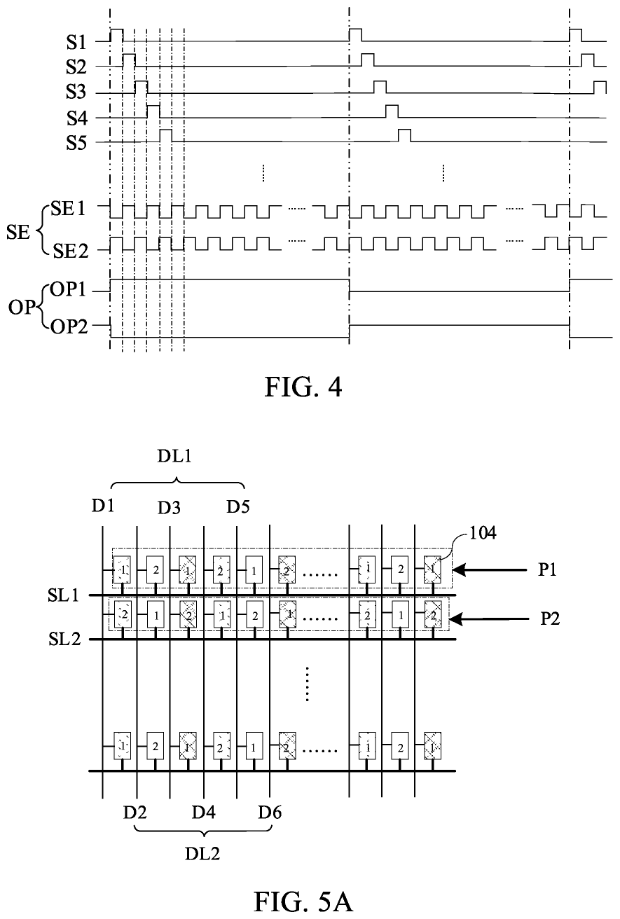

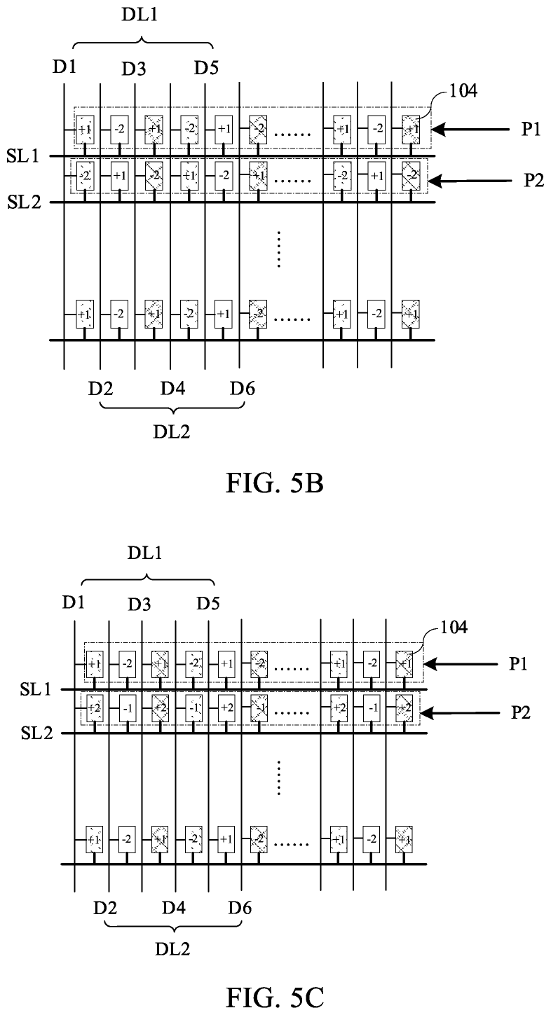

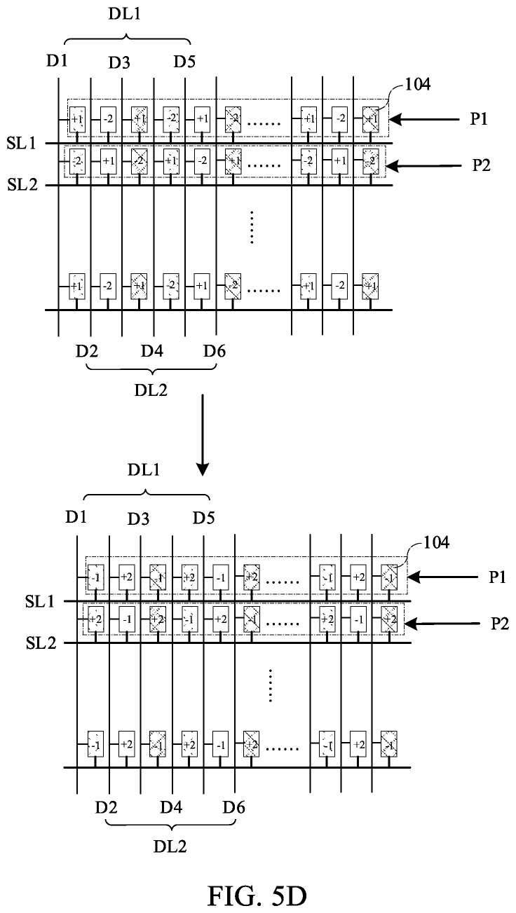

Please refer to FIG. 4, which is a control sequence diagram of gamma selection signals and polarity selection signals provided by one embodiment of the present application. Taking the first data line DL1 representing the odd-number data lines of the arrangement number in the plurality of data lines DataL, and the second data line data line DL2 representing the even-number data lines of the arrangement number in the plurality of data lines DataL as an example, and with reference to the control sequence of FIG. 4, a working principle of the connection structures data lines, the power management module, and the driving chip illustrated FIGS. 3A to 3B is described. FIG. 5A is a schematic diagrams of results of adopting the control sequence illustrated in FIG. 4 to control the connection structures illustrated in FIG. 3A to FIG. 3B. Wherein, in FIG. 5A, the marked “1” on the sub-pixel 104 indicates that the sub-pixel 104 displays according to the first-group grayscale voltage, and the marked “2” on the sub-pixel 104 indicates that the sub-pixel 104 displays according to the second-group grayscale voltage.

When a high electric level of the first scanning signal S1 loaded on the first scanning signal line SL1 is valid, and a low electric level of the first gamma selection signal SE1 loaded on the first gamma selection signal line SEL1 is valid, the first switch T11 in the first switch unit and the first switch T12 in the second switch unit are turned off simultaneously, the plurality of sub-pixels 104 located in a first pixel row P1 and located in odd columns are connected to the first data line DL1 through the corresponding pixel driving circuit, thereby display is performed according to the first-group grayscale voltage converted by the first voltage conversion module 1021a; and the plurality of sub-pixels 104 located in the first pixel row P1 and located in even columns are connected to the second data line DL2 through the corresponding pixel driving circuit, thereby display is performed according to the second-group grayscale voltage converted by the second voltage conversion module 1021b.

When a high electric level of the second scanning signal S2 loaded on the second scanning signal line SL2 is valid, and a low electric level of the second gamma selection signal SE2 loaded on the second gamma selection signal line SEL2 is valid, the second switch T21 in the first switch unit and the second switch T22 in the second switch unit are turned off simultaneously, the plurality of sub-pixels 104 located in a second pixel row P2 and located in odd columns are connected to the first data line DL1 through the corresponding pixel driving circuit, thereby display is performed according to the second-group grayscale voltage converted by the second voltage conversion module 1021b; and the plurality of sub-pixels 104 located in the second pixel row P2 and located in even columns are connected to the second data line DL2 through the corresponding pixel driving circuit, thereby display is performed according to the first-group grayscale voltage converted by the first voltage conversion module 1021a. As so on, situations when the other scan signals are valid at high electric level can be obtained correspondingly, and redundant description will not be mentioned herein again.

By making the two adjacent sub-pixels 104 in each pixel row display according to different groups of grayscale voltages, and by making the two adjacent sub-pixels 104 in each pixel column also display according to different groups of grayscale voltages, the liquid crystal molecules are allowed to deflect more, thereby remedying the problem of color shift of viewing angles. Furthermore, compared to current designs of using an 8-domain pixel structure to remedy the color shift, adopting a 4-domain design in the structure of each sub-pixel 104 can ensure the transmittance rate of the display panel to not be affected.

When same grayscales are displayed, the corresponding grayscale voltage values in the plurality of groups of the grayscale voltages are different are different, i.e., when the same grayscales are displayed, slight difference exists in the corresponding grayscale voltage values in the plurality of groups of the grayscale voltages, so there is a flicker problem when the two adjacent data lines DataL switch to receive different groups of grayscale voltages. In order to prevent the flicker problem, the driving chip 102 further includes a plurality of polarity conversion modules 1023. As illustrated in (b) and (c) of FIG. 2, the plurality of polarity conversion modules 1023 are electrically connected between the voltage conversion module 1021 and the plurality of data lines DataL, and the plurality of polarity conversion modules 1023 are configured to allow two adjacent data lines DataL to receive grayscale voltages of different polarities. The polarity conversion module 1023 allows two adjacent data lines to receive grayscale voltages of different polarities, so difference between the plurality of groups of grayscale voltages is weakened when the plurality of groups of grayscale voltages are used for display, thereby remedying the flicker problem.

Furthermore, each of the polarity conversion modules 1023 includes a non-inverting amplifier. The amplifier includes an inverting amplifier or a non-inverting amplifier. Optionally, as illustrated in FIG. 3C, and FIG. 3G to FIG. 3H, each of the polarity conversion modules 1023 is connected between one of the voltage conversion modules 1021 and one of the switch units; or as illustrated in FIG. 3D to FIG. 3E, each of the polarity conversion modules 1023 is connected between one of the switch units and the two adjacent data lines DataL; or as illustrated in FIG. 3F, each of the switch units is connected to two of the voltage conversion modules 1023, and each of the polarity conversion modules 1023 is connected between one of the switch units and one of the data lines DataL.

For ease of understanding, the present application is described by taking the polarity conversion module 1023 including two polarity conversion modules of a first polarity conversion module 1023a and a second polarity conversion module 1023b as an example. FIG. 3C and FIG. 3G to FIG. 3H are schematic diagrams corresponding to the connection structures of the data lines, the power management module, and the driving chip illustrated in (b) of FIG. 2. FIG. 3D to FIG. 3F are schematic diagrams corresponding to the connection structures of the data lines, the power management module, and the driving chip illustrated in (c) of FIG. 2.

Please continue referring to FIG. 3C, the first polarity conversion module 1023a is connected between the first voltage conversion module 1021a and the first switch unit, which allows the first voltage conversion module 1021a to be electrically connected to one of the first data line DL1 or the second data line DL2 through the first polarity conversion module 1023a and the first switch unit. The second polarity conversion module 1023b is connected between the second voltage conversion module 1021b and the second switch unit, which allows the second voltage conversion module 1021b to be electrically connected to another one of the first data line DL1 or the second data line DL2 through the first polarity conversion module 1023a and the second switch unit.

Specifically, the first polarity conversion module 1023a includes a non-inverting amplifier. The non-inverting amplifier is electrically connected between the two first ends of the first switch T11 and the second switch T21 of the first switch unit and the first voltage conversion module 1021a. The second polarity conversion module 1023b includes an inverting amplifier. The inverting amplifier is electrically connected between the two first ends of the first switch T12 and the second switch T22 of the second switch unit and the second voltage conversion module 1021b.

Please continue referring to FIG. 3D. The first polarity conversion module 1023a is connected between the first switch unit, the first data line DL1, and the second data line DL2, and the second polarity conversion module 1023b is connected between the second switch unit, the first data line DL1, and the second data line DL2. Specifically, the first polarity conversion module 1023a includes two non-inverting amplifiers. One of the two non-inverting amplifiers is electrically connected between the second end of the first switch T11 of the first switch unit and the first data line DL1. Another one of the two non-inverting amplifiers is electrically connected between the second end of the second switch T21 of the first switch unit and the second data line DL2. The second polarity conversion module 1023b includes two inverting amplifiers. One of the two inverting amplifiers is electrically connected between the second end of the first switch T12 of the second switch unit and the second data line DL2. Another one of the two inverting amplifiers is electrically connected between the second end of the second switch T22 of the second switch unit and the first data line DL1. The first end of the first switch T11 and the first end of the second switch T21 in the first switch unit are both electrically connected to the first voltage conversion module 1021a. The first end of the first switch T12 and the first end of the second switch T22 in the second switch unit are both electrically connected to the second voltage conversion module 1021b.

Please continue referring to FIG. 3C to FIG. 3D. When the first gamma selection signal SE1 is valid, the first data line DL1 is connected to the first voltage conversion module 1021a through the first switch T11 in the first switch unit and the first polarity conversion module 1023a, the first data line DL1 receives the first-group grayscale voltage of a positive polarity, the second data line DL2 is connected to the second voltage conversion module 1021b through the first switch T12 in the second switch unit and the second polarity conversion module 1023b, and the second data line DL2 receives the second-group grayscale voltage of a negative polarity. When the second gamma selection signal SE2 is valid, the second data line DL2 is connected to the second voltage conversion module 1021b through the second switch T22 in the second switch unit and the second polarity conversion module 1023b, the first data line DL1 receives the second-group grayscale voltage of the negative polarity, the second data line DL2 is connected to the first voltage conversion module 1021a through the second switch T21 in the first switch unit and the first polarity conversion module 1023a, and the second data line DL2 receives the first-group grayscale voltage of the positive polarity.

Please refer to FIG. 5B, which is a schematic diagram of results of adopting the control sequence illustrated in FIG. 4 to control the connection structures illustrated in FIG. 3C to FIG. 3D. Wherein, in FIG. 5B, the marked “+1” on the sub-pixel 104 indicates that the sub-pixel 104 displays according to the first-group grayscale voltage of the positive polarity; the marked “+2” on the sub-pixel 104 indicates that the sub-pixel 104 displays according to the second-group grayscale voltage of the positive polarity; the marked “−1” on the sub-pixel 104 indicates that the sub-pixel 104 displays according to the first-group grayscale voltage of the negative polarity; and the marked “−2” on the sub-pixel 104 indicates that the sub-pixel 104 displays according to the second-group grayscale voltage of the negative polarity.

When a first scanning signal S1 is valid at high electric level, and the first gamma selection signal SE1 is valid at low electric level, the first switch T11 in the first switch unit and the first switch T12 in the second switch unit are turned off simultaneously, the plurality of sub-pixels 104 located in a first pixel row P1 and located in odd columns are connected to the first data line DL1 through the corresponding pixel driving circuit, thereby display is performed according to the first-group grayscale voltage of the positive polarity; and the plurality of sub-pixels 104 located in the first pixel row P1 and located in even columns are connected to the second data line DL2 through the corresponding pixel driving circuit, thereby display is performed according to the second-group grayscale voltage of the negative polarity. When a second scanning signal S2 is valid at high electric level, and the second gamma selection signal SE2 is valid at low electric level, the second switch T21 in the first switch unit and the second switch T22 in the second switch unit are turned off simultaneously, the plurality of sub-pixels 104 located in a second pixel row P2 and located in odd columns are connected to the first data line DL1 through the corresponding pixel driving circuit, thereby display is performed according to the second-group grayscale voltage of the negative polarity; and the plurality of sub-pixels 104 located in the second pixel row P2 and located in even columns are connected to the second data line DL2 through the corresponding pixel driving circuit, thereby display is performed according to the first-group grayscale voltage of the positive polarity. As so on, situations when the other scan signals are valid at high electric level can be obtained, and redundant description will not be mentioned herein again.

Please continue referring to FIG. 3E. The first polarity conversion module 1023a and the second polarity conversion module 1023b both include a non-inverting amplifier and an inverting amplifier. The non-inverting amplifier in the first polarity conversion module 1023a is electrically connected between the second end of the first switch T11 of the first switch unit and the first data line DL1. The inverting amplifier in the first polarity conversion module 1023a is electrically connected between the second end of the second switch T21 of the first switch unit and the second data line DL2. The inverting amplifier in the second polarity conversion module 1023b is electrically connected between the second end of the first switch T12 of the second switch unit and the second data line DL2. The non-inverting amplifier in the second polarity conversion module 1023b is electrically connected between the second end of the second switch T22 of the second switch unit and the first data line DL1.

Please continue referring to FIG. 3F. On the basis of the connection structure of the data lines, the power management module, and the driving chip illustrated in FIG. 3B, the polarity conversion module 1023 is located between one of the switch units and one of the data lines DataL. Specifically, the first polarity conversion module 1023a includes a non-inverting amplifier. The non-inverting amplifier is electrically connected between the two second ends of the first switch T11 and the second switch T21 of the first switch unit and the first data line DL1. The second polarity conversion module 1023b includes an inverting amplifier. The inverting amplifier is electrically connected between the two second ends of the first switch T12 and the second switch T22 of the second switch unit and the second data line DL2.

Please continue referring to FIG. 3E to FIG. 3F. When the first gamma selection signal SE1 is valid, the first data line DL1 is connected to the first voltage conversion module 1021a through the first polarity conversion module 1023a and the first switch T11 in the first switch unit, the first data line DL1 receives the first-group grayscale voltage of a positive polarity, the second data line DL2 is connected to the second voltage conversion module 1021b through the second polarity conversion module 1023b and the first switch T12 in the second switch unit, and the second data line DL2 receives the second-group grayscale voltage of a negative polarity.

Please continue referring to FIG. 3E, When the second gamma selection signal SE2 is valid, the first data line DL1 is connected to the second voltage conversion module 1021b through the second polarity conversion module 1023b and the second switch T22 in the second switch unit and, and the first data line DL1 receives the first-group grayscale voltage of a positive polarity; and the second data line DL2 is connected to the first voltage conversion module 1021a through the first polarity conversion module 1023a and the second switch T21 in the first switch unit, and the second data line DL2 receives the first-group grayscale voltage of the negative polarity.

Please continue referring to FIG. 3F, When the second gamma selection signal SE2 is valid, the first data line DL1 is connected to the second voltage conversion module 1021b through the first polarity conversion module 1023a and the second switch T21 in the first switch unit, the first data line DL1 receives the second-group grayscale voltage of the positive polarity; and the second data line DL2 is connected to the first voltage conversion module 1021a through the second polarity conversion module 1023b and the second switch T22 in the second switch unit 1022a, and the second data line DL2 receives the first-group grayscale voltage of the negative polarity.

Please refer to FIG. 5C, which is a schematic diagram of results of adopting the control sequence illustrated in FIG. 4 to control the connection structures illustrated in FIG. 3E to FIG. 3F. When a first scanning signal S1 is valid at high electric level, and the first gamma selection signal SE1 is valid at low electric level, the first switch T11 in the first switch unit and the first switch T12 in the second switch unit are turned off simultaneously, the plurality of sub-pixels 104 located in a first pixel row P1 and located in odd columns are connected to the first data line DL1 through the corresponding pixel driving circuit, thereby display is performed according to the first-group grayscale voltage of the positive polarity; and the plurality of sub-pixels 104 located in the first pixel row P1 and located in even columns are connected to the second data line DL2 through the corresponding pixel driving circuit, thereby display is performed according to the second-group grayscale voltage of the negative polarity. When a second scanning signal S2 is valid at high electric level, and the second gamma selection signal SE2 is valid at low electric level, the second switch T21 in the first switch unit and the second switch T22 in the second switch unit are turned off simultaneously, the plurality of sub-pixels 104 located in a second pixel row P2 and located in odd columns are connected to the first data line DL1 through the corresponding pixel driving circuit, thereby display is performed according to the second-group grayscale voltage of the positive polarity; and the plurality of sub-pixels 104 located in the second pixel row P2 and located in even columns are connected to the second data line DL2 through the corresponding pixel driving circuit, thereby display is performed according to the first-group grayscale voltage of the negative polarity. As so on, situations when the other scan signals are valid at high electric level can be obtained, and redundant description will not be mentioned herein again.

Optionally, besides the amplifiers, the polarity conversion module 1023 can also include switches, which allow a polarity of the grayscale voltage converted by the voltage conversion module in a current frame to be opposite to a polarity of the grayscale voltage converted in a previous frame. Therefore, after the end of one frame, a state of the liquid crystal molecules is changed to remedy a phenomenon of polarization of the liquid crystal molecules.

Furthermore, each of the polarity conversion modules 1023 includes a third switch T3 and a fourth switch T4 which are interlocked. The third switches T3 in the plurality of polarity conversion modules 1023 are interlocked, and the fourth switches T4 in the plurality of polarity conversion modules 1023 are interlocked. Optionally, the first switch T3 and the second switch T4 can be transistors. A control end of the third switch T3 and a control end of the fourth switch T4 can be connected to one same polarity selection signal line. Types of the third switch T3 and the fourth switch T4 are different, so that validly interlocking of the third switch T3 and the fourth switch T4 is realized. Optionally, the control end of the third switch T3 and the control end of the fourth switch T4 can also be connected to different polarity selection signal lines, and phases of a frame inverting signal loaded in the polarity selection signal line connected to the control end of the third switch T3 and a frame inverting signal loaded in the polarity selection signal line connected to the control end of the fourth switch T4 are opposite.

For ease of understanding, the present application is still described by taking the polarity conversion module 1023 including two polarity conversion modules of the first polarity conversion module 1023a and the second polarity conversion module 1023b as an example. Specifically, please continue referring to FIG. 3G to FIG. 3H. The first polarity conversion module 1023a and the second polarity conversion module 1023b both include a non-inverting amplifier, an inverting amplifier, the third switch T3, and the fourth switch T4.

The non-inverting amplifier in the first polarity conversion module 1023a is coupled in series with the third switch T31. The inverting amplifier is coupled in series with the fourth switch T41. A control end of the third switch T31 is electrically connected to a third polarity selection signal line OPL1. A control end of the fourth switch T41 is electrically connected to a fourth polarity selection signal line OPL2. Wherein, the non-inverting amplifier and the third switch T31 coupled in series are parallelly connected to the inverting amplifier and the fourth switch T41 coupled in series to form a first branch, and the first branch is electrically connected between the first voltage conversion module 1021a and the two first ends of the first switch T11 and the second switch T21 of the first switch unit.

The inverting amplifier in the second polarity conversion module 1023b is coupled in series with the third switch T32. The non-inverting amplifier is coupled in series with the fourth switch T42. A control end of the third switch T32 is electrically connected to a third polarity selection signal line OPL1. A control end of the fourth switch T42 is electrically connected to a fourth polarity selection signal line OPL2. Wherein, the inverting amplifier and the third switch T32 coupled in series are parallelly connected to the non-inverting amplifier and the fourth switch T42 coupled in series to form a second branch, and the second branch is electrically connected between the second voltage conversion module 1021b and the two first ends of the first switch T12 and the second switch T22 of the second switch unit.

The third polarity selection signal line OPL1 and the fourth polarity selection signal line OPL2 are respectively configured to transmit a first-frame inverting signal OP1 and a second-frame inverting signal OP2. Wherein, the first-frame inverting signal OP1 and the second-frame inverting signal OP2 have opposite phases. If a high electric level of the first-frame inverting signal OP1 is valid, a high electric-level duration of the first-frame inverting signal OP1 is equal to a duration of one frame.

When the first-frame inverting signal OP1 is valid, the third switch T31 in the first polarity conversion module 1023a and the third switch T32 in the second polarity conversion module 1023b are turned off simultaneously. If the first gamma selection signal SE1 is valid at this time, then the first data line DL1 is connected to the first voltage conversion module 1021a through the first switch T11 in the first switch unit and the first polarity conversion module 1023a, and the first data line DL1 receives the first-group grayscale voltage of a positive polarity; and the second data line DL2 is connected to the second voltage conversion module 1021b through the first switch T12 in the second switch unit and the second polarity conversion module 1023b, and the second data line DL2 receives the second-group grayscale voltage of a negative polarity. If the second gamma selection signal SE2 is valid at this time, the first data line DL1 is connected to the second voltage conversion module 1021b through the first switch T12 in the second switch unit 1022a and the second polarity conversion module 1023b, and the first data line DL1 receives the second-group grayscale voltage of the negative polarity; and the second data line DL2 is electrically connected to the first voltage conversion module 1021a through the second switch T21 in the first switch unit and the first polarity conversion module 1023a, and the second data line DL2 receives the first-group grayscale voltage of the positive polarity.

When the second-frame inverting signal OP2 is valid, the fourth switch T41 in the first polarity conversion module 1023a and the fourth switch T42 in the second polarity conversion module 1023b are turned off simultaneously. If the first gamma selection signal SE1 is valid at this time, then the first data line DL1 is connected to the first voltage conversion module 1021a through the first switch T11 in the first switch unit and the first polarity conversion module 1023a, and the first data line DL1 receives the first-group grayscale voltage of the negative polarity; and the second data line DL2 is connected to the second voltage conversion module 1021b through the first switch T12 in the second switch unit and the second polarity conversion module 1023b, and the second data line DL2 receives the second-group grayscale voltage of the positive polarity. If the second gamma selection signal SE2 is valid at this time, the first data line DL1 is connected to the second voltage conversion module 1021b through the second switch T22 in the second switch unit 1022a and the second polarity conversion module 1023b, and the first data line DL1 receives the first-group grayscale voltage of a positive polarity; and the second data line DL2 is connected to the first voltage conversion module 1021a through the second switch T21 in the first switch unit and the first polarity conversion module 1023a, and the second data line DL2 receives the first-group grayscale voltage of the negative polarity.

Please refer to FIG. 5D, which is a schematic diagram of results of adopting the control sequence illustrated in FIG. 4 to control the connection structures illustrated in FIG. 3G to FIG. 3H. When the first-frame inverting signal OP1 is valid at high electric level, the third switch T31 in the first polarity conversion module 1023a and the third switch T32 in the second polarity conversion module 1023b are turned off simultaneously. When a first scanning signal S1 is valid at high electric level, and the first gamma selection signal SE1 is valid at low electric level, the first switch T11 in the first switch unit and the first switch T12 in the second switch unit are turned off simultaneously, the plurality of sub-pixels 104 located in a first pixel row P1 and located in odd columns are connected to the first data line DL1 through the corresponding pixel driving circuit, thereby display is performed according to the first-group grayscale voltage of the positive polarity; and the plurality of sub-pixels 104 located in the first pixel row P1 and located in even columns are connected to the second data line DL2 through the corresponding pixel driving circuit, thereby display is performed according to the second-group grayscale voltage of the negative polarity. When a second scanning signal S2 is valid at high electric level, and the second gamma selection signal SE2 is valid at low electric level, the first-frame inverting signal OP1 still remains at high electric level, the third switch T31 in the first polarity conversion module 1023a and the third switch T32 in the second polarity conversion module 1023b are maintained in a turned-off state, the second switch T21 in the first switch unit and the second switch T22 in the second switch unit are turned off simultaneously, the plurality of sub-pixels 104 located in a second pixel row P2 and located in odd columns are connected to the first data line DL1 through the corresponding pixel driving circuit, thereby display is performed according to the second-group grayscale voltage of the negative polarity; and the plurality of sub-pixels 104 located in the second pixel row P2 and located in even columns are connected to the second data line DL2 through the corresponding pixel driving circuit, thereby display is performed according to the first-group grayscale voltage of the positive polarity. As so on, in the time of one frame, situations when the other scan signals are valid at high electric level can be obtained, and redundant description will not be mentioned herein again.

At a time of the end of one frame, the first-frame inverting signal OP1 hops from a high electric level to a low electric level, the second-frame inverting signal OP2 hops from a low electric level to a high electric level, and the fourth switch T41 in the first polarity conversion module 1023a and the fourth switch T42 in the second polarity conversion module 1023b are turned off simultaneously. When a first scanning signal S1 is valid at high electric level, and the first gamma selection signal SE1 is valid at low electric level, the first switch T11 in the first switch unit and the first switch T12 in the second switch unit are turned off simultaneously, the plurality of sub-pixels 104 located in a first pixel row P1 and located in odd columns are connected to the first data line DL1 through the corresponding pixel driving circuit, thereby display is performed according to the first-group grayscale voltage of the negative polarity; and the plurality of sub-pixels 104 located in the first pixel row P1 and located in even columns are connected to the second data line DL2 through the corresponding pixel driving circuit, thereby display is performed according to the second-group grayscale voltage of the positive polarity. When a second scanning signal S2 is valid at high electric level, and the second gamma selection signal SE2 is valid at low electric level, the second-frame inverting signal OP2 still remains at the high electric level, the fourth switch T41 in the first polarity conversion module 1023a and the fourth switch T42 in the second polarity conversion module 1023b are maintained in a turned-off state, the second switch T21 in the first switch unit and the second switch T22 in the second switch unit are turned off simultaneously, the plurality of sub-pixels 104 located in a second pixel row P2 and located in odd columns are connected to the first data line DL1 through the corresponding pixel driving circuit, thereby display is performed according to the second-group grayscale voltage of the positive polarity; and the plurality of sub-pixels 104 located in the second pixel row P2 and located in even columns are connected to the second data line DL2 through the corresponding pixel driving circuit, thereby display is performed according to the first-group grayscale voltage of the negative polarity. As so on, in the time of one frame, situations when the other scan signals are valid at high electric level can be obtained, and redundant description will not be mentioned herein again.

Optionally, the display panel further includes a time schedule controller. The time schedule controller is located in the non-display region 100b. The time schedule controller is electrically connected to the gamma selection signal lines SEL and the polarity selection signal lines OPL, and it is configured to generate gamma selection signals and frame inverting signals to transmit the gamma selection signals to the gamma selection signal lines SEL and to transmit the frame inverting signal to the polarity selection signal lines OPL.

Furthermore, the time schedule controller is electrically connected to the first gamma selection signal line SEL1 and the second gamma selection signal line SEL2. The time schedule controller is configured to generate a first gamma selection signal SE1 and a second gamma selection signal SE2 which have opposite phases and to respectively transmit the first gamma selection signal SE1 and the second gamma selection signal SE2 to the first gamma selection signal line SEL1 and the second gamma selection signal line SEL2. The time schedule controller is electrically connected to the third polarity selection signal line OPL1 and the fourth polarity selection signal line OPL2. The time schedule controller is configured to generate the first-frame inverting signal OP1 and the second-frame inverting signal OP2 which have opposite phases and to respectively transmit the first-frame inverting signal OP1 and the second-frame inverting signal OP2 into the third polarity selection signal line OPL1 and the fourth polarity selection signal line OPL2.

It can be understood that the first data line DL1 and the second data line DL2 can represent two adjacent data lines during practical applications. A number of the voltage conversion modules 1021, the voltage selection modules, and the polarity conversion modules 1023 included in the driving chip is not limited to two.

One embodiment of the present application provides a display device. The display device includes any of the aforesaid display panel.

The above describes the embodiments of the present application in detail. This article uses specific cases for describing the principles and the embodiments of the present application, and the description of the embodiments mentioned above is only for helping to understand the method and the core idea of the present application. Meanwhile, for those skilled in the art, will have various changes in specific embodiments and application scopes according to the idea of the present application. In summary, the content of the specification should not be understood as limit to the present application.

1. A display panel, comprising:
a plurality of data lines comprising a first data line and a second data line which are adjacent;
a power management module configured to generate a plurality of different groups of gamma binding-point voltages, wherein the plurality of groups of the gamma binding-point voltages comprise a first-group gamma binding-point voltage and a second-group gamma binding-point voltage; and
a driving chip, wherein the driving chip comprises a voltage conversion module, the voltage conversion module is electrically connected between the power management module, the first data line, and the second data line, the voltage conversion module is configured to convert the first-group gamma binding-point voltage into a first-group grayscale voltage and outputs the first-group grayscale voltage to one of the first data line or the second data line, and is configured to convert the second-group gamma binding-point voltage into a second-group grayscale voltage and outputs the second-group grayscale voltage to another one of the first data line or the second data line; and
wherein the first-group gamma binding-point voltage is different from the second-group gamma binding-point voltage, and the first-group grayscale voltage is different from the second-group grayscale voltage.

2. The display panel as claimed in claim 1, wherein an absolute value of the first-group grayscale voltage is different from an absolute value of the second-group grayscale voltage, or a polarity of the first-group grayscale voltage is different from a polarity of the second-group grayscale voltage.

3. The display panel as claimed in claim 1, wherein the driving chip further comprises a voltage selection module, and the voltage selection module is electrically connected between the voltage conversion module, the first data line, and the second data line.

4. The display panel as claimed in claim 3, wherein the voltage conversion module comprises a first voltage conversion module and a second voltage conversion module, the voltage selection module comprises a first switch unit and a second switch unit, the first switch unit is electrically connected between the first voltage conversion module, the first data line, and the second data line, and the second switch unit is electrically connected between the second voltage conversion module, the first data line, and the second data line.

5. The display panel as claimed in claim 4, wherein the first switch unit and the second switch unit both comprise a first switch and a second switch;
wherein in the first switch unit, a first end and a second end of the first switch are electrically connected between the first voltage conversion module and the first data line, a control end of the first switch is electrically connected to a first gamma selection signal line, a first end and a second end of the second switch are electrically connected between the first voltage conversion module and the second data line, and a control end of the second switch is electrically connected to a second gamma selection signal line; and
in the second switch unit, a first end and a second end of the first switch are electrically connected between the second voltage conversion module and the second data line, a control end of the first switch is electrically connected to the first gamma selection signal line, a first end and a second end of the second switch are electrically connected between the second voltage conversion module and the first data line, and a control end of the second switch is electrically connected to the second gamma selection signal line.

6. The display panel as claimed in claim 5, wherein the driving chip further comprises a polarity conversion module, and the polarity conversion module comprises:
a first polarity conversion module, wherein the first polarity conversion module is electrically connected between the first voltage conversion module and one of the first data line or the second data line; and
a second polarity conversion module, wherein the second polarity conversion module is electrically connected between the second voltage conversion module and another one of the first data line or the second data line; and
wherein the first polarity conversion module and the second polarity conversion module are configured to allow a polarity of the first-group grayscale voltage and a polarity of the second polarity conversion module to be opposite.

7. The display panel as claimed in claim 6, wherein the first polarity conversion module comprises a non-inverting amplifier, the non-inverting amplifier is electrically connected between the two first ends of the first switch and the second switch of the first switch unit and the first voltage conversion module, the second polarity conversion module comprises an inverting amplifier, and the inverting amplifier is electrically connected between the two first ends of the first switch and the second switch of the second switch unit and the second voltage conversion module.

8. The display panel as claimed in claim 6, wherein the first polarity conversion module and the second polarity conversion module both comprise a non-inverting amplifier, an inverting amplifier, a third switch, and a fourth switch,
wherein in the first polarity conversion module, the non-inverting amplifier is coupled in series with the third switch, a control end of the third switch is electrically connected to a third polarity selection signal line, the inverting amplifier is coupled in series with the fourth switch, and a control end of the fourth switch is electrically connected to a fourth polarity selection signal line,
the non-inverting amplifier and the third switch coupled in series are parallelly connected to the inverting amplifier and the fourth switch coupled in series to form a first branch, and
the first branch is electrically connected between the first voltage conversion module and the two first ends of the first switch and the second switch of the first switch unit; and
in the second polarity conversion module, the inverting amplifier is coupled in series with the third switch, a control end of the third switch is electrically connected to the third polarity selection signal line, the non-inverting amplifier is coupled in series with the fourth switch, and the control end of the fourth switch is electrically connected to the fourth polarity selection signal line,
the inverting amplifier and the third switch coupled in series are parallelly connected to the non-inverting amplifier and the fourth switch coupled in series to form a second branch, and
the second branch is electrically connected between the second voltage conversion module and the two first ends of the first switch and the second switch of the second switch unit.

9. The display panel as claimed in claim 5, wherein the display panel further comprises:
a time schedule controller electrically connected to the first gamma selection signal line and the second gamma selection signal line and configured to generate a first gamma selection signal and a second gamma selection signal which have opposite phases, and to respectively transmit the first gamma selection signal and the second gamma selection signal to the first gamma selection signal line and the second gamma selection signal line, and wherein a low electric-level duration of the first gamma selection signal is same as a charging time of pixels of one row.

10. The display panel as claimed in claim 8, wherein the display panel further comprises:
a time schedule controller electrically connected to the third polarity selection signal line and the fourth polarity selection signal line and configured to generate a first-frame inverting signal and a second-frame inverting signal which have opposite phases, and to respectively transmit the first-frame inverting signal and the second-frame inverting signal into the third polarity selection signal line and the fourth polarity selection signal line, and wherein a high electric-level duration of the first-frame inverting signal is equal to a duration of one frame.

11. The display panel as claimed in claim 3, wherein the voltage conversion module comprises a first voltage conversion module and a second voltage conversion module, the voltage selection module comprises a first switch unit and a second switch unit, the first switch unit is electrically connected between the first voltage conversion module and the first data line and between the second voltage conversion module and the first data line, and the second switch unit is electrically connected between the first voltage conversion module and the second data line and between the first voltage conversion module and the second data line.

12. The display panel as claimed in claim 11, wherein the first switch unit and the second switch unit both comprise a first switch and a second switch;
the first voltage conversion module is electrically connected between the power management module and a first end of the first switch in the first switch unit and between the power management module and a first end of the second switch in the second switch unit, the second voltage conversion module is electrically connected between the power management module and a first end of the second switch in the first switch unit and between the power management module and a first end of the first switch in the second switch unit, second ends of the first switch and the second switch in the first switch unit are electrically connected to the first data line, second ends of the first switch and the second switch in the second switch unit are electrically connected to the second data line, a control end of the first switch in the first switch unit and a control end of the first switch in the second switch unit are electrically connected to a first gamma selection signal line; and a control end of the second switch in the first switch unit and a control end of the second switch in the second switch unit are electrically connected to a second gamma selection signal line.

13. The display panel as claimed in claim 12, wherein the driving chip further comprises a polarity conversion module, the polarity conversion module comprises a first polarity conversion module and a second polarity conversion module; the first polarity conversion module comprises a non-inverting amplifier, the non-inverting amplifier is electrically connected between the two second ends of the first switch and the second switch of the first switch unit and the first data line; the second polarity conversion module comprises an inverting amplifier, and the inverting amplifier is electrically connected between the two second ends of the first switch and the second switch of the second switch unit and the second data line.

14. The display panel as claimed in claim 6, wherein the first polarity conversion module comprises two non-inverting amplifiers, one of the two non-inverting amplifiers is electrically connected between the second end of the first switch of the first switch unit and the first data line, and another one of the two non-inverting amplifiers is electrically connected between the second end of the second switch of the first switch unit and the second data line; the second polarity conversion module comprises two inverting amplifiers, one of the two inverting amplifiers is electrically connected between the second end of the first switch of the second switch unit and the second data line, and another one of the two inverting amplifiers is electrically connected between the second end of the second switch of the second switch unit and the first data line; the first end of the first switch and the first end of the second switch in the first switch unit are electrically connected to the first voltage conversion module; and the first end of the first switch and the first end of the second switch in the second switch unit are electrically connected to the second voltage conversion module.

15. The display panel as claimed in claim 6, wherein the first polarity conversion module and the second polarity conversion module both comprise a non-inverting amplifier and an inverting amplifier, the non-inverting amplifier in the first polarity conversion module is electrically connected between the second end of the first switch of the first switch unit and the first data line, and the inverting amplifier in the first polarity conversion module is electrically connected between the second end of the second switch of the first switch unit and the second data line; and the inverting amplifier in the second polarity conversion module is electrically connected between the second end of the first switch of the second switch unit and the second data line, and the non-inverting amplifier in the second polarity conversion module is electrically connected between the second end of the second switch of the second switch unit and the first data line.

16. A display device, comprising a display panel, wherein the display panel comprises:
a plurality of data lines comprising a first data line and a second data line which are adjacent;
a power management module configured to generate a plurality of different groups of gamma binding-point voltages, wherein the plurality of groups of the gamma binding-point voltages comprise a first-group gamma binding-point voltage and a second-group gamma binding-point voltage; and
a driving chip, wherein the driving chip comprises a voltage conversion module, the voltage conversion module is electrically connected between the power management module, the first data line, and the second data line, the voltage conversion module is configured to convert the first-group gamma binding-point voltage into a first-group grayscale voltage and outputs the first-group grayscale voltage to one of the first data line or the second data line, and is configured to convert the second-group gamma binding-point voltage into a second-group grayscale voltage and outputs the second-group grayscale voltage to another one of the first data line or the second data line; and
wherein the first-group gamma binding-point voltage is different from the second-group gamma binding-point voltage, and the first-group grayscale voltage is different from the second-group grayscale voltage.

17. The display device as claimed in claim 16, wherein an absolute value of the first-group grayscale voltage is different from an absolute value of the second-group grayscale voltage, or a polarity of the first-group grayscale voltage is different from a polarity of the second-group grayscale voltage.

18. The display device as claimed in claim 16, wherein the driving chip further comprises a voltage selection module, and the voltage selection module is electrically connected between the voltage conversion module, the first data line, and the second data line.

19. The display device as claimed in claim 18, wherein the voltage conversion module comprises a first voltage conversion module and a second voltage conversion module, the voltage selection module comprises a first switch unit and a second switch unit, the first switch unit is electrically connected between the first voltage conversion module, the first data line, and the second data line, and the second switch unit is electrically connected between the second voltage conversion module, the first data line, and the second data line.

20. The display device as claimed in claim 19, wherein the driving chip further comprises a polarity conversion module, and the polarity conversion module comprises:
a first polarity conversion module, wherein the first polarity conversion module is electrically connected between the first voltage conversion module and one of the first data line or the second data line; and
a second polarity conversion module, wherein the second polarity conversion module is electrically connected between the second voltage conversion module and another one of the first data line or the second data line; and
wherein the first polarity conversion module and the second polarity conversion module are configured to allow a polarity of the first-group grayscale voltage and a polarity of the second polarity conversion module to be opposite.
